(19) United States
(12) Patent Application Publication
(10) Pub. No.: US 2021/0186078 A1
(43) Pub. Date: Jun. 24, 2021

(54) PLANT-BASED WHEY PROTEIN POWDER REPLACEMENT

(71) Applicants: Carmen Oliver, Oakville (CA); Gustavo Galez, Oakville (CA); Raza Bashir, Oakville (CA); Vaishali Joshi, Oakville (CA)

(72) Inventors: Carmen Oliver, Oakville (CA); Gustavo Galez, Oakville (CA); Raza Bashir, Oakville (CA); Vaishali Joshi, Oakville (CA)

(73) Assignee: Northern Innovations Holding Corp., Oakville (CA)

(21) Appl. No.: 17/127,731

(22) Filed: Dec. 18, 2020

Related U.S. Application Data
(60) Provisional application No. 62/949,992, filed on Dec. 18, 2019.

(51) Int. Cl. A23L 33/185; A23J 1/14; A23L 33/115; A23L 33/22

(52) U.S. Cl. CPC A23L 33/185; A23J 1/14; A23V 2002/00; A23L 33/22; A23L 33/115

(57) ABSTRACT

A plant-based food supplement is provided that approximates the taste, texture, and flexibility of use of whey protein powder and is suitable as a substitute for whey protein powder. The plant-based food supplement has a base of faba bean protein combined with at least one additional plant-based ingredient. The plant-based supplement provides a source of protein for use in a variety of contexts, primarily as a powder for mixing with liquids.

### FIELD OF THE INVENTION

The present invention relates generally to protein supplement powders. More specifically, the present invention relates to plant-based protein supplement powders made primarily from faba bean and at least one other plant-based ingredient that approximate the taste and texture of whey protein and may be used as a dairy-free alternative.

### BACKGROUND OF THE INVENTION

Protein is an essential macromolecule and is a focus of many specific diets and many nutritional supplements, particularly supplements for exercise/sport performance and recovery. Individuals typically include protein supplements in their diet to ensure adequate protein intake to maintain or increase skeletal muscle mass and to support muscle repair. Protein sources are broadly of two categories—animal-based and plant-based—and may be assessed under various parameters including amino acid profile (amounts of essential amino acids and branched-chain amino acids), being complete versus incomplete proteins, and source (animal versus plant).

Plant-based foods are increasingly being sought, both to supplement the diet and to supplant animal-based foods. There are some suggestions and evidence that consumption of more plant-based foods is associated with improved health markers. Incidence of allergies to whey proteins have been observed. Also, it has been suggested that plant-based food sources are, overall, more environmentally friendly. For some individuals there is also an ethical motivation to choosing plant-based foods over animal-based. These factors are driving increased interest in plant-based foods. While the protein from plant-based foods generally has lower digestibility and absorption comparted to animal-based foods, due at least partially to anti-nutrients, processing (for example, to produce concentrates and isolates) results in comparable digestibility.

While increasing consumption of plant-based food may simply be in the form of increasing intake of non-animal-based foods, such as eating more plant-based foods as part of a typical diet (e.g. salads, fruit snacks), there is also a drive to produce plant-based foods that mimic the taste and texture of a corresponding animal-based food to more easily incorporate them. This is most evident in meat and milk substitutes.

Dairy milk substitutes are water extracts processed in such a way to resemble dairy milk. Such products are also often called “milk”. Soy milk is arguably the most recognizable dairy milk replacement. Soy milk has received negative attention for the amount of anti-nutrients and phytoestrogens. Other common dairy milk substitutes include almond milk which tends to be low in protein, rice milk which tends to also be low in protein while being higher in carbohydrate, and coconut milk which is low in protein. Most plant-based dairy milk alternatives must be fortified, usually with calcium and vitamin D, to make them more nutritionally comparable to dairy.

Whey protein is presently one of the most common and popular protein choice for protein supplements. Whey is one of the two main components of dairy milk, the other being casein, which is also a popular supplement category. Alternatively, both whey and casein may be provided as a blend. Whey is generally a preferred choice due to its faster absorption and amino acid profile.

There exists a need for a plant-based food product that will have similar qualities, such as taste, texture, and mixability, to whey protein powder when used either mixed with liquid for drinking or when used in cooking.

### SUMMARY OF THE INVENTION

In an aspect of the present invention there is provided a plant-based food composition configured to approximate the taste, texture, and mixability of whey powder, the plant-based food comprising processed faba bean and at least one other processed plant-based food.

In some aspects of the present invention the processed faba bean is at least one of a faba bean protein isolate, a faba bean protein concentrate, or mixtures thereof. In some embodiments the processed faba bean is a mixture of faba bean concentrate and faba bean isolate. In further embodiments the amount of faba bean concentrate is greater than the amount of faba bean isolate.

In some aspects of the present invention the other processed plant-based food is chickpea. In some embodiments the other processed plant-based food is chickpea protein concentrate. In other embodiments the other processed plant-based food is soluble corn fiber.

In some embodiments the plant-based food composition provides at least 15 grams of protein per serving. In further embodiments the composition provides from about 20 grams to 30 grams of protein per serving. In still further embodiments the composition provides less than 20 grams of carbohydrates per serving. In yet further embodiments the composition provides less than 9 grams of sugar per serving.

### DETAILED DESCRIPTION OF THE EMBODIMENTS

As used herein, “approximate the taste, texture, and mixability of whey powder” refers generally to compositions other than whey protein that have qualities such as taste, texture (both powdered and in a mixture or solution), and mixability in various liquids, typically water. Specifically, it refers to plant-based compositions that have one or more of these qualities similar to those of whey protein.

With reference to whey protein, processing results in different types of whey supplements, all typically provided as powders, as a commodity for use as nutritional supplements and has the general goal of increasing the protein portion. Whey concentrate is the least processed and therefore cheapest of the types and contains relatively high amounts of carbohydrates and fats. Whey isolate is processed to remove more carbohydrate and fat, yielding more protein. Of note, the major carbohydrate of milk/whey is lactose, which is difficult for many individuals to properly metabolize, prompting the choice of whey isolate over whey concentrate. This also is the reason some individuals seek plant-based protein options over dairy-based. Hydrolyzed whey or whey hydrolysate is yet further processed by treating whey with enzymes or acid to breakdown some of the protein to peptides and free amino acids (sometimes equated to pre-digestion), making it easier and quicker to digest.

As used herein, “processed plant-based food” refers to any plant material that has been subjected to some form of post-harvesting processing. At the most basic level this may involve steps such as drying, grinding, or pulverizing. More advanced processing steps may include those required to obtain extracts, concentrates, or isolates, particularly to obtain protein or increase the protein fraction.

The described embodiments are intended to be examples of the present invention and alterations and modifications may be made thereto, by those of skill in the art. The scope of the claims should not be limited by the preferred embodiments set forth in the examples but should be given the broadest interpretation consistent with the description as a whole.

It was desired to create a plant-based alternative to whey protein that would approximate the taste and texture of whey protein for flexible use as a dairy alternative. It was particularly desired to formulate a plant-based dairy substitute useful in all instances where whey protein powder would be used but particularly in mixed beverages such as shakes and smoothies. In certain embodiments, the compositions would be high in protein or high in protein and low in carbohydrate. In certain other embodiments the compositions would be any or all of soy free, dairy free, and gluten free.

After preliminary research and testing, the process of approximating the taste, texture, and mixability of whey protein powder focused on a base of faba bean (Vicia faba, also known as fava bean, or broad bean), as faba bean seemed to have many of the desired characteristics. The most favorable results were obtained with combinations of faba bean protein and at least one other plant-based material, which other material may be predominantly protein, fiber, or mixtures thereof. It was found that chickpea protein as the other plant-based material resulted in compositions with the desired characteristics, particularly chickpea protein concentrate. It was also discovered that soluble corn fiber may be suitable as the other plant-based material. Two early formulas gave particularly favorable results, designated Option #2 and Option #4. Option #2 was formulated with: 39.43 grams 60% faba bean concentrate, 4.6 grams 90% faba bean isolate, 2 grams soluble corn fiber, and 1.35 grams 75% Acacia powder. Option #4 was formulated with: 17.8 grams 60% faba bean concentrate, 15.43 grams 90% faba bean isolate, 5.25 grams 60% chickpea protein concentrate, 2 grams soluble corn fiber, and 1.35 grams 75% Acacia powder. Each of Option #2 and #4 were formulated with and without a bitter masker. It was found the 300 mg of commercial bitter masker greatly improved taste. The four compositions were assessed for texture, taste, and bitterness. Results are presented in Table 1.

TABLE 1

| | | Option #2 with 0.3 g | | Option #4 with 0.3 g |
|---|---|---|---|---|
| UNFLAVORED | Option #2 | of bitter masker | Option #4 | of bitter masker |
| Average | 3.94 | 3.33 | 1.98 | 1.58 |
| bitterness | | | | |
| score | | | | |
| (1- Cleanest | | | | |
| taste, 5- most | | | | |
| bitter) | | | | |
| Comments | -thicker | -bitter notes | Nice aftertaste | Least bitter (4) |
| | -slightly | -no chickpea notes | Strong bean | -no chickpea notes |
| | grainy | -less bitter | aftertaste | |
| | -most | bitter | chickpea | |
| | aftertaste | | | |

Subsequent formulations were tested giving favorable results. For example, a formulation as follows was made: 15.28 g faba bean protein concentrate 60%, 8.96 g fava bean protein isolate, 4.51 g chickpea protein concentrate, 1.72 g soluble corn fiber, 1.23 g MCT (medium-chain triglyceride) oil 70%, and additional flavorings and excipients. In some instances, the addition of bitter masker greatly improves the taste of the resulting composition. Also, in some instances, the addition of MCT oils greatly improves the taste and texture of the resulting composition.

Overall, it was found that a base composition of mostly faba bean protein concentrate extracts, followed by lesser amounts of faba bean protein isolate, and a smaller amount of chickpea protein extracts (for example Option #4) provided the closest similarity to a target whey protein concentrate 65%. In particular, replacing at least a small amount (˜3%) of the

faba bean concentrate with chickpea protein concentrate resulted in less viscosity and improved color. One preferred base composition comprises about 50% of the total protein coming from faba bean isolate, about 38% coming from faba bean concentrate, and about 12% coming from chickpea protein concentrate.

For use in mixed beverages, as a replacement for whey protein, a serving of the composition may provide 20-30 g of protein, and preferably should provide at least 15 g of protein per serving. The composition may, in some uses, be a low carbohydrate, protein composition, providing less than 20 g of carbohydrate per serving. Furthermore, in some uses, the composition may provide less than 9 g of sugar.

The compositions of the present invention may be combined with additional ingredients as would be customary for the intended particular use. For example, additional ingredients may include excipients, flavorings, thickeners, surfactants, or any food or nutritional supplemental ingredients. For use in shakes and smoothies, the present compositions may be configured to be mixed with any suitable liquid, such as water, fruit juice, or dairy alternatives, for individuals avoiding dairy/meat products. For individuals merely wishing to incorporate more plant-based material while not totally avoiding dairy, the present compositions may be suitable for mixing with dairy milk. The present compositions may be any desired flavor such as, but not limited to, unflavored, chocolate, vanilla, peanut butter, coffee, mint, any fruit flavor, or combinations or variations thereof.

The present compositions may preferably be produced, packaged, and provided as a dry powdered composition in a format containing multiple servings (e.g. bottles, tubs, resealable bags/pouches). Alternatively, the present compositions may be provided as liquid formulations (e.g. ready-to-drink, or RTD) for single servings (e.g. cans, small cartons) or multi-servings (e.g. large cartons). Further alternatively, the present compositions may be produced, packaged, and provided in solid food-type articles such as cookies, cakes, muffins, nutritional crisps, chips, bites and bars, or mixes for such articles.

The above-described embodiments are intended to be examples of the present invention and alterations and modifications may be effected thereto, by those of skill in the art. The skilled artisan will recognize that many modifications are possible, without parting from the invention consistent with the description. The scope of the claims should not be limited by the preferred embodiments set forth in the examples, but should be given the broadest interpretation consistent with the description as a whole.

What is claimed is:

1. A plant-based food composition configured to approximate the taste, texture, and mixability of whey powder, the plant-based food comprising processed faba bean and at least one other processed plant-based food.

2. The composition of claim 1, wherein the processed faba bean is at least one of a faba bean protein isolate, a faba bean protein concentrate, or mixtures thereof.

3. The composition of claim 2, wherein the processed faba bean is a mixture of protein concentrate and isolate.

4. The composition of claim 1, wherein the at least one other processed plant-based food is chickpea or soluble corn fiber.

5. The composition of claim 2, wherein the at least one other processed plant-based food is chickpea or soluble corn fiber.

6. The composition of claim 3, wherein the at least one other processed plant-based food is chickpea or soluble corn fiber.

7. The composition of claim 4, wherein the chickpea is a chickpea protein concentrate.

8. The composition of claim 5, wherein the chickpea is a chickpea protein concentrate.

9. The composition of claim 6, wherein the chickpea is a chickpea protein concentrate.

10. The composition of claim 3, wherein the amount of faba bean concentrate is greater than the amount of faba bean isolate.

11. The composition of claim 6, wherein the amount of faba bean concentrate is greater than the amount of faba bean isolate.

12. The composition of claim 9, wherein the amount of faba bean concentrate is greater than the amount of faba bean isolate.

13. The composition of claim 1, wherein the composition provides at least 15 grams of protein per serving.

14. The composition of claim 5, wherein the composition provides at least 15 grams of protein per serving.

15. The composition of claim 10, wherein the composition provides at least 15 grams of protein per serving.

16. The composition of claim 13, wherein the composition provides less than 20 grams of carbohydrate.

17. The composition of claim 14, wherein the composition provides less than 20 grams of carbohydrate.

18. The composition of claim 15, wherein the composition provides less than 20 grams of carbohydrate.

19. A plant-based food composition configured to approximate the taste, texture, and mixability of whey powder, the plant-based food comprising faba bean, chickpea, and bitter masker.

20. The composition of claim 19, further comprising MCT oil.

21. A plant-based food composition configured to approximate the taste, texture, and mixability of whey powder, the plant-based food comprising: 15.28 grams of faba bean protein concentrate 60%, 8.96 grams of faba bean protein isolate, 4.51 grams of chickpea protein concentrate, 1.72 grams of soluble corn fiber, 1.23 grams of MCT (medium-chain triglyceride) oil 70%, and additional flavorings and excipients.
